(19) United States
(12) Patent Application Publication
(10) Pub. No.: US 2012/0276260 A1
(43) Pub. Date: Nov. 1, 2012

(54) DEVICE, SYSTEM, AND METHOD FOR LOW TEMPERATURE SMOKING ON A GRILL

(76) Inventor: Darin J. Duncan, Dallas, TX (US)

(21) Appl. No.: 13/453,398

(22) Filed: Apr. 23, 2012

Related U.S. Application Data
(63) Continuation-in-part of application No. 12/620,048, filed on Nov. 17, 2009.
(60) Provisional application No. 61/631,650, filed on Jan. 9, 2012.

(51) Int. Cl. A23B 4/052; A47J 37/07

(52) U.S. Cl. 426/314; 126/25 R

(57) ABSTRACT

A modular portable grill, having an enclosure defining a cooking space, cooking surfaces for holding food and exposing it to circulating air and smoke operably connected to the cooking enclosure and in the superior portion of the enclosure, a plurality of heating elements in the lower portion of the enclosure, above the heating elements a removable drawer for solid fuel, and directly above the drawer an optional liquid tray. The grill can be configured as a traditional grill, when the drawer and water tray are removed. With insertion of either the solid fuel drawer alone, or with both the solid fuel drawer and water tray, it produces smoke from the solid fuel drawer and steam from the water tray. Thus, this grill enables, within a single cooking enclosure, three cooking techniques: traditional high temperature grilling, high temperature smoking, and low temperature smoking.

### CROSS REFERENCE TO OTHER APPLICATIONS

This is a Continuation in Part application of application Ser. No. 12/620048 filed Nov. 17. 2009 and of provisional application 61/631650 filing date claiming the benefit of the filing date Jan. 9, 2012, and are all herein incorporated by reference.

### BACKGROUND OF THE INVENTION

It is generally known that home cooks desire to produce consistently appetizing food requiring a minimum of effort and skill. Common outdoor cooking devices include devices fueled by propane, charcoal, natural gas, or wood in some combination. These devices, which offer a wide variety of cooking structures and cooking methods, use different combinations of temperature, smoke, humidity, and food placement in order to transform raw food into a superior finished product. These devices include have names such as gas grills, charcoal grills, ceramic grills, electric smokers, gas smokers, water smokers, and slow smokers, among others. The most common, most popular, and easiest to use of these is the simple propane grill. The present invention represents a modification of the standard propane grill. This modification preserves the ability of the grill to perform high temperature grilling in an undiminished fashion. But the modification allows incorporation of solid fuel and water into the cooking process, for the purpose of improving flavor of the food product. While preserving intact the original function of the grill, the modification enables high temperature smoking and low temperature smoking, on a cooking tool that traditionally only performs high temperature grilling. In addition, it offers a simplified, more reliable version of the smoking process, whereby the user first flavors, the cooks, their food.

Gas grills are the leading category of outdoor cooking product. Despite its popularity, the gas grill itself has one major drawback, a relative lack of flavor. Smokers, on the other hand, produce much better tasting food, but require purchase of a single purpose devise, as well as a great deal of time and patience and skill during the cooking process. For this reason, smokers have not achieved the sales success of gas grills.

The various devices described above produce three different cooking techniques. High temperature grilling utilizes temperatures above 325 degrees to produce flavor by searing, which produces caramelization of sugars or the Maillard reaction in proteins. High temperature smoking occurs with temperatures typically above 250 degrees and is similar to high temperature grilling, but with the addition of flavor elements from the combustion of solid fuel. Low temperature smoking occurs below 250 degrees, and therefore excludes the Maillard reaction, deriving flavor from the combustion of solid fuel and typically extending the cooking time in order to facilitate the breakdown of connective tissue present in many meats.

The difference in taste between traditional gas grill and smokers derives from the use of wood as a flavoring element. That same flavoring element, wood, flavors the wines of Bordeaux, the bourbon of

Kentucky and Scotland, the traditional balsamic vinegar of Modena, and the barbecue of Texas, North Carolina, and Kansas City. By optionally adding wood to the grilling environment, the quality of the food product is greatly improved. By integrating wood flavor into a traditional grill, the objective is to also integrate the passion and dedication shown by so many BBQ cooks, and to make true BBQ available to many who have never tried to cook BBQ. Examples of woods used in cooking include alder, apple, cherry, chokecherry, hickory, maple, mesquite, oak, pecan, as well wood products made from wine and whiskey barrels and many others.

When making any decision on cooking technique, a variety of factors are weighed. It is the goal of all outdoor cooking devices to create excellent food product, with great consistency, requiring the least user skill and effort, and having a low cost to own and operate. The present invention uniquely discloses a device that is able to achieve these objectives by enabling three cooking techniques in a single enclosure: high temperature grilling, high temperature smoking, and low temperature smoking, while requiring a minimum of user skill and effort.

The present invention retains in an undiminished fashion its ability to perform high temperature grilling. The unique design elements of this grill, the drawer and the water tray, can be removed or reconfigured in a manner that does not interfere with the ability of the grill to obtain the high temperatures that product superior food product when performing high temperature grilling, especially when cooking steaks or other meats that derive flavor from searing, also known as the Maillard reaction. None of the currently available products is able to perform all three cooking techniques without limitation of the grilling function, or limitation of the smoking function by relying on grilling function to smoke thereby unavoidably raising the temperatures above the ideal smoking and par-cooking level.

One device that employs the slow smoking technique is traditional slow smoker. While they are very effective in producing outstanding product, there is limited use by home cooks, due to the high cost of purchasing and operating them, the skill required in using them, and the time and effort involved in starting a wood fire and maintaining it within the desired temperature levels for the extended time required by low temperature smoking. The poor temperature control of these devices, and the inability to achieve high temperature grilling, has resulted in limited use of this otherwise superior cooking technique.

The use of propane has become so widespread as to be the most popular of all grilling methods, despite the near universal agreement that food cooked over wood or charcoal is more flavorful. Propane grills offer excellent convenience, simplicity of use, and cleanliness. But they do possess one major drawback and that is lack of flavor, relative to the flavor produced by charcoal grills or smokers.

Charcoal fires are believed to produce better tasting food than propane fires. For this reason, they remain a popular cooking tool. But there are additional difficulties when using charcoal, compared to gas. Unlike gas, charcoal fires do not have instantaneous temperature control. Rather, you use vents to control oxygen flow to the coals. In addition, the fuel itself is cumbersome. Third, there is significant effort required to start your fire, as compared to the push button simplicity of a gas grill. Ash disposal is another difficulty.

Infrared grills have gained popularity of the years. These grills often produce better tasting food that standard gas grills by achieving a higher temperature at the grill grate, which promotes the searing process. But these grills have drawbacks as well. First, and like many gas grills, they often have trouble achieving lower temperatures that many foods require. Second, infrared grills are significantly more expensive to manufacture than standard gas grills.

Certain products have attempted to superficially combine the functions of a smoker and grill, by simply bolting together the two structures without adequate consideration for combining the requisite physical structures in a manner consistent with the specific qualities of each step of the process. These products fall far short of the invention here disclosed. Specifically they are structurally deficient to carry out combining the solid fuel drawers and the water tray in a manner that reduces temperatures, improves humidity, and baffles the heat and smoke in an even manner throughout the grill.

The present invention enables three cooking techniques in one enclosure: high temperature grilling, high temperature smoking, and low temperature smoking. When configured for high temperature grilling, the elements that provide smoke or humidity can be removed, resulting in undiminished grilling temperatures and performance. High temperature smoking results when the solid fuel drawer and water tray are deployed, with the heating elements adjusted to create cooking temperatures of 250 degrees or more. Low temperature smoking, used in “low and slow BBQ”, is performed at temperatures below 250 degrees, and is achieved by deploying the solid fuel drawer and the water tray together, but either minimizing heat from the plurality of heating elements, or eliminating their use entirely.

Many kinds of food benefit from the aromaticity of wood flavors. These foods include beef, poultry, pork, seafood, vegetables and fruit. It is the intent of this grill design to simplify the performance of high temperature smoking by using the lower heating element to ignite the solid fuel in the solid fuel drawer. This contrasts with manual fire starting required by traditional smokers. One example of a very important item to be cooked this way is whole turkey, which is frequently consumed during holidays or on special occasions such as family events. This high temperature smoking technique, which employs temperatures of 325 degrees or more, can be deployed with or without the optional water tray, and the present invention uniquely enables this valuable technique.

The solid fuel drawer serves several purposes. First, when removed, the gas grill operates normally as a gas grill without diminishment of performance. Second, the drawer is designed as a baffle, so that convection currents travel around the sides of the drawer and reach the cooking surface, resulting in lower cooking temperatures and even distribution of heat. Third, the drawer offers users the ability to refill solid fuel without disturbing the food or opening the lid, an important feature during long slow cooking sessions. The drawer is intended to be solid, for the purpose of containing and disposing of ash, and preventing the ash from falling onto the burners, possibly corroding them or interfering with their performance or the performance of their venturis. The solid bottom also slows solid fuel combustion, preventing flare-ups and lengthening the smoking time of the solid fuel. The solid bottom of the drawer acts as a heat shield, diffusing heat and reducing the temperature at the cooking surface.

The removable water tray is a redesign of an existing grill part, commonly known as a flavorizer bar, which was originally patented in U.S. Pat. No. 4,627,408 by Erich Schlosser. Unlike the Schlosser design, the intent is not to maximize cooking temperatures, but rather to minimize the temperature at the cooking surface. As it is placed directly below the cooking surface, it is refillable without interrupting the cooking process. The water tray acts as a heat sink, absorbing heat from below and reducing cooking temperatures. The present grill design can be configured for high temperature grilling, in which case a flavorizer bar configuration will merely prevent flare-ups. When configured to perform either high temperature or low temperature smoking, the water tray element may be deployed, having the effect of reducing cooking temperatures and humidifying the environment. The water tray has the additional trait of baffling air and heat flow, thereby generating even smoke and heat dispersion throughout the cooking enclosure. Lastly, the use of aromatic liquids may improve the flavor of certain foods. In fact, the flavorizer bar and water tray may be a single grill part. The difference in function will be determined by the placement of the part in the grill. When configured as a “U” or a “V” shape, the device functions as a water container. When inverted, the same part serves as a flavorizer bar, as generally envisioned in U.S. Pat. No. 4,627,408. Alternatively, the grill may use two separate parts, one of which is a flavorizer bar, the second of which is a water tray. Each of the two parts may have different mounting points, as best suits the grill function. The key to function is that the user will pick the optimal configuration for the each cooking session.

The purpose of the water tray is four-fold. First, it acts as a heat sink, reducing the realized temperature of the cooking environment. A consequence of the attempt to raise the temperature at the cooking surface to the highest possible level, to better create the flavoring reaction known as the Maillard reaction, is that gas grills frequently are unable to achieve the necessary low and slow cooking temperatures requires for cooking, for example, briskets. One objective of this grill is to avoid the Maillard reaction entirely, as this is harmful to BBQ. Briskets can require ten or more hours to complete cooking, but even in the absence of a Maillard reaction, if temperatures exceed 250 degrees for an extended time, the brisket may dry out or sear. The lower temperature created by the water, which boils at 212 degrees, which is near to the ideal low temperature smoking temperature of 225 degrees, and optionally the complete elimination of heat from the heating elements enables long, low temperature smoking sessions. The second purpose of the water tray configuration is to humidify the cooking enclosure and therefore prevent dehydration of food. Third, it assists in creating even heat and smoke distribution throughout the cooking enclosure. Fourth, it can be refilled without disturbing the cooking process. There are many examples of prior art that demonstrate a failure disclose an inventions that address these concerns.

The water tray possesses an additional benefit not disclosed in prior art. The process of caramelization, or the Maillard reaction, requires a temperature in excess of the boiling point of water. For example, sucrose caramelizes at 320 degrees Farenheit. All foods on a grill, naturally, are well below the boiling point of water, even when cooked. At a given temperature, additional humidity results in higher levels of moisture on the external surface of the food, thus preventing caramelization. This benefit is unexpected, as it is generally understood that observed temperature is an adequate indicator of the rate of cooking. High humidity also makes the cooking process more reliable for novice cooks, as cooks can safely tolerate flare-ups without destroying their meat.

The present invention allows for the ease of use of cooking with propane and enables the slow smoking and fast processes. When slow smoking is performed, there is much greater control of humidity and smoke than when using a traditional wood fire, because the cook has direct control of the water and wood inputs. Also, temperature control is much improved because the propane flame is easier to control than a wood fire. Less cooking time is required when slow smoking because the flame is instantly lit or put out, where lighting a wood fire is time consuming, requires practice, and is less safe than lighting a propane grill. So the present invention allows for the proper cooking and smoking of a brisket, or other meat requiring slow cooking, while a traditional propane grill cannot do this.

The present invention requires less skill when deploying the low temperature smoking process.

Slow smoking generally requires significant experience, and involves a great deal of trial and error learning how to make wood fires, to control the fire, and to control the smoke and humidity of the cooking environment. But the present invention retains one of the main benefits of a traditional high temperature cooking process, the ability to toggle the burner elements for instantaneous temperature control. Traditional slow smokers, on the other hand, exhibit significant difficulties in controlling their wood fires, which are subject to both flare-ups, and to temperatures too low for adequate cooking, due to the narrow range of acceptable temperatures, generally between 200 and 250 degrees.

Further advantages of the present invention are demonstrated by the data provided in table 1. Unlike examples from the related art, the unique range and control of cooking conditions inside the grill enable uses and cooking processes not possible on the devices referenced herein.

It is well known in the art that there is an art to culinary skill and it is not a perfect science. Therefore a device such as the invention disclosed here, that provides for a unique range of capabilities and level of control pertaining to functions such as temperature control, humidity, and baffling not possible on the other devices clearly distinguishes the current invention from the devices in the related art. The devices of the related art are not capable of achieving the performance parameters of the present invention. The failure of the references disclosed herewith this application to accomplish the performance parameters of the device speak to both the long felt need and the failure of others to effectively combine the functionalities of a smoker, grill, and humidifier in a single gas powered grill.

Gagas discloses a device with containers for alternating between gas and solid fuels. These containers are not removable and are not disclosed to be filled with water unlike the current invention, elements claimed and supported by the specification herein. Additional elements of the current invention such as the specific cooking process disclosed herein are not disclosed in the references of the relevant art and as discussed in other parts of this specification are not capable of doing so due to their design limitations. The Gagas et all reference identified fails to at least teach or suggest above the solid fuel drawer, a liquid tray, for humidification and temperature reduction. The Thompson reference, the reference generally discloses placing a wood smoker inside a barbeque structure in combination with a water basin. The reference does not teach other liquids disclosed in the specification herewith (using sweet flavored liquids, wines, teas or spices, etc]. Further, it is of note that the two step process described in at least claim 17 is not enabled by the reference as the burner's proximity to the food will expose it to at least some direct flame on its lowest setting, thereby disabling the par-cooking process on the Guidry apparatus.

The invention as claimed has utility in that it provides for flavorizing with solid fuel combustion, humidification, with the control and speed of a controllable gas grill in a single device. It further allows for par-cooking, flavoring, or smoking , then searing food to finish on a single device, while maintaining moistness through the humidifying element. Unlike the all of the disclosed references this can be carried out without touching or moving the food or stopping to interchange functional elements of device. Additionally it does so with indirect heat from a single burner as well as direct heat from actuating multiple burners, a clear distinction from the prior art. The invention simplifies, shortens, and provides more options during the smoking process, and greatly expands the utility of not only the standard grill but grill smoker combination products.

The present invention uniquely enables a new, two step cooking process. First, the food is flavored, or cooked at low temperature with solid fuel smoke combustion. It is best to consider the wood flavoring as a kind of airborne marinade, where the strength of flavoring is related to time exposed to the marinade. This process occurs with the heating elements set to the lowest possible setting or off, in order to deliver extremely low cooking temperatures below 200 degrees. The resulting food product is parcooked. The second step is to raise the cooking temperature to above 325 degrees, to complete the cooking process. This step herein is referred to as cooking to completion, and is demarcated by the food being fully cooked, as opposed to raw or undercooked, such that it is safe for consumption. This two step cooking process cannot be performed on traditional smokers, as they lack secondary heating elements, or on traditional grills, which lack wood flavoring capability. What makes the this invention able to perform this technique is the combination of solid fuel integration with the ability to perform high temperature grilling, without so much as even moving the food. It replicates the well known dual zone cooking technique, but does so in one device.

### BRIEF SUMMARY OF THE INVENTION

It is the principal object of the present invention to provide for a portable grilling apparatus capable of producing great tasting food with a minimum amount of cooking effort.

It is another object of the invention to enable multiple cooking techniques in a single device, including high temperature grilling, high temperature smoking, and low temperature smoking, enabling consumers to avoid costs associated with owning and operating multiple devices.

It is one object of the present invention to use humidification to reduce reduce or prevent searing during the low temperature smoking.

It is one object of the present invention to enable the low temperature smoking process by enabling the user to refill the solid fuel drawer while the grill is in use.

It is one object of the present invention to enable the low temperature smoking process by enabling the user to refill the water trays while the grill is in use.

It is yet another object of the invention to provide a portable cooking apparatus that the user can optionally configure for different cooking processes.

It is another object of the invention to require less skill to achieve excellent cooking results by allowing for continuous control of the internal environment of the cooking device.

It is another object of the invention to provide an optional smoking function that does not interfere with the traditional high temperature grilling process.

It is another object of the invention to produce great food product more consistently by allowing for simple and continuous control of the humidity of the cooking enclosure.

It is another object of the invention to enable a two step cooking process, whereby the user first flavors and then cooks their food, which is unique to this apparatus.

Other objects and advantages of the present invention will be apparent by reference to the following description of the instant embodiment, drawings, and claims.

### BRIEF DESCRIPTION OF THE DRAWINGS

These and other features, aspects, and advantages of the present invention will become better understood with regard to the following description, claims, and accompanying drawings:

FIG. 1 is an anterior view of the preferred embodiment of the invention.

FIG. 2 is a top view of the grilling enclosure with the upper portion of the cooking enclosure removed.

FIG. 3 is a top view of the preferred embodiment of the cooking enclosure, with the and cooking surfaces

FIG. 4a is a sectional view of the interior of the cooking enclosure of the preferred embodiment with

FIG. 4b is a sectional view of the interior of the cooking enclosure in the second embodiment, with the

FIG. 5 is a perspective view of the refillable drawer of the preferred embodiment.

FIG. 6a is one embodiment of the water tray, in the inverted position.

FIG. 6b is the same embodiment of the water tray, in the water tray position.

FIGS. 7a and 7b show alternative embodiments of the water trays.

FIG. 8 is a second embodiment of the invention, but including two water trays above two solid fuel drawers.

FIG. 9 is a third embodiment of the invention, but including two water trays above two solid fuel drawers.

FIG. 10 is another embodiment of the invention whereby the solid fuel drawer is not included, and only a liquid tray is positioned between the heat source and the grill and food location.

FIG. 11 discloses another embodiment of six liquid trays and solid fuel drawers.

FIG. 12 discloses another embodiment of exactly two liquid trays and solid fuel drawers.

FIG. 13 discloses another embodiment of two solid fuel drawers and liquid trays, each drawer and liquid tray spanning two burners.

Table 1 is the results from direct temperature and condition measurements.

### DETAILED DESCRIPTION OF THE INVENTION

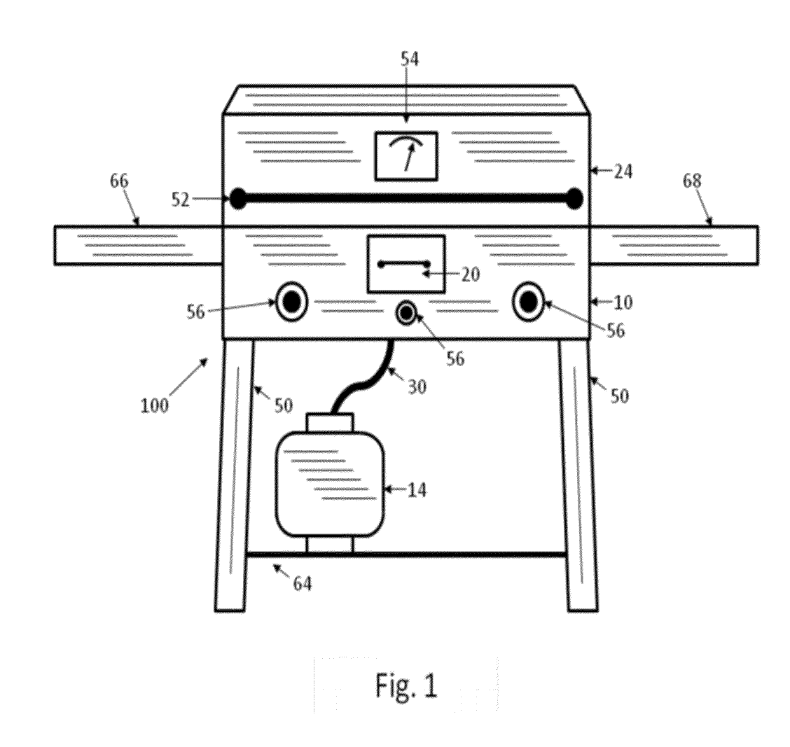

Referring to FIGS. 1, 2, 3, 4a and 4b, in the preferred embodiment, a gas grill 100 comprising a cooking enclosure 10, mounted upon a support structure of four individual supporting legs 50, left and right sided shelves 66 and 68, a fuel source 14, a means of delivering fuel to the cooking enclosure 30, and within the cooking enclosure gas burners 28, a removable drawer assembly 20, and cooking surfaces 22 for holding food and exposing food to the cooking environment. Control of gas flow, and therefore temperatures as well as humidity and smokiness, is by gas valves, not shown, actuated by user interfaces 56. The support structure is in this embodiment made up of four legs 50, and a lower shelf 64 for the fuel source 14 which delivers fuel to the burner elements by means of tubing 16. The cooking enclosure has an upper portion 24, holding a temperature gauge 54, which opens by means of a handle 52.

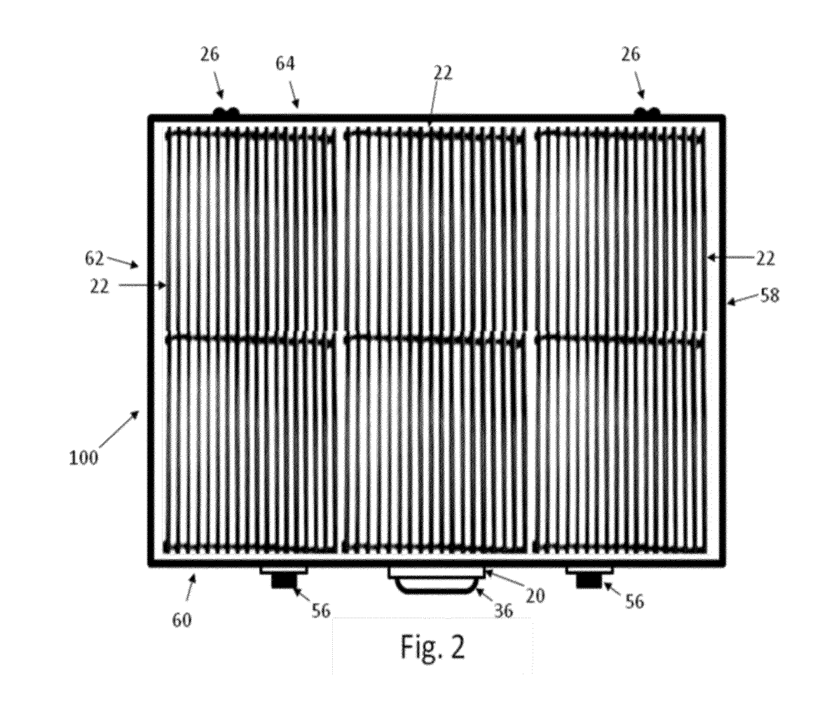

FIG. 2, the top view of grill 100 with the upper portion of the cooking enclosure 24 removed, shows posteriorly placed hinges 26. The enclosure demonstrates the cooking perspective with the drawer and optional water trays in place. The enclosure has left and right opposed sides 62 and 58 as well as front and back opposed sides 60 and 64. One embodiment of a cooking surface 24 is shown. The user interfaces are seen in 56, and the solid fuel drawer 20 with handle 36. In FIG. 2 the side shelves 66 and 68 are not shown.

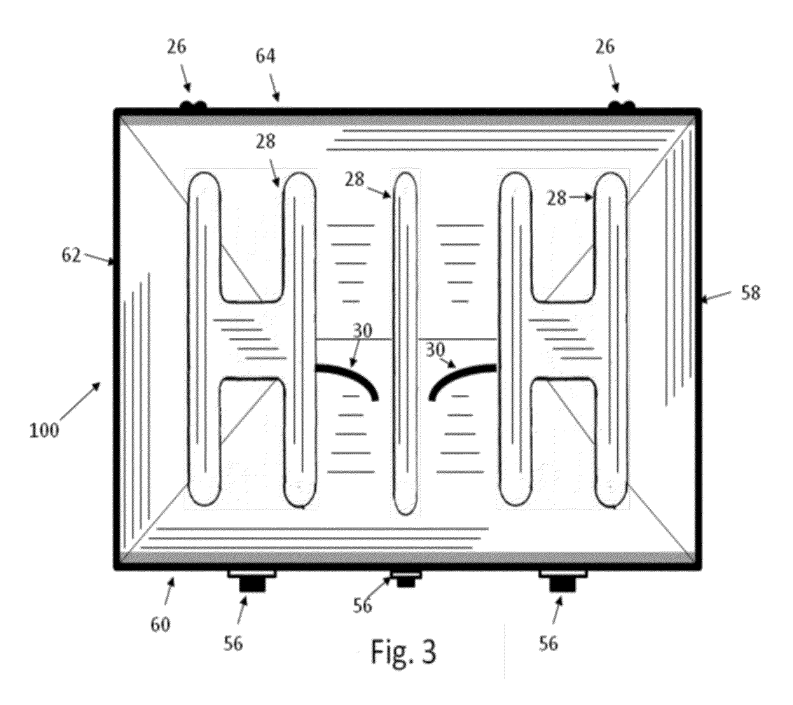

FIG. 3 shows the cooking enclosure with the upper portion 24 of the cooking enclosure 10 removed, and with the side shelves 66 and 68 removed. In addition, the drawer 20 and the flavorizer bars are removed. At the lower portion of the cooking enclosure are several gas burners 28. These burners 28, in other embodiments, will substantially vary in shape, BTU capacity, placement, and number according to needs of the customer and design of the particular grill. Fuel is delivered to the burners by gas lines 30. This figure, in conjunction with FIG. 2, demonstrates that when configured for high temperature grilling, performance of the high temperature grilling process is undisturbed.

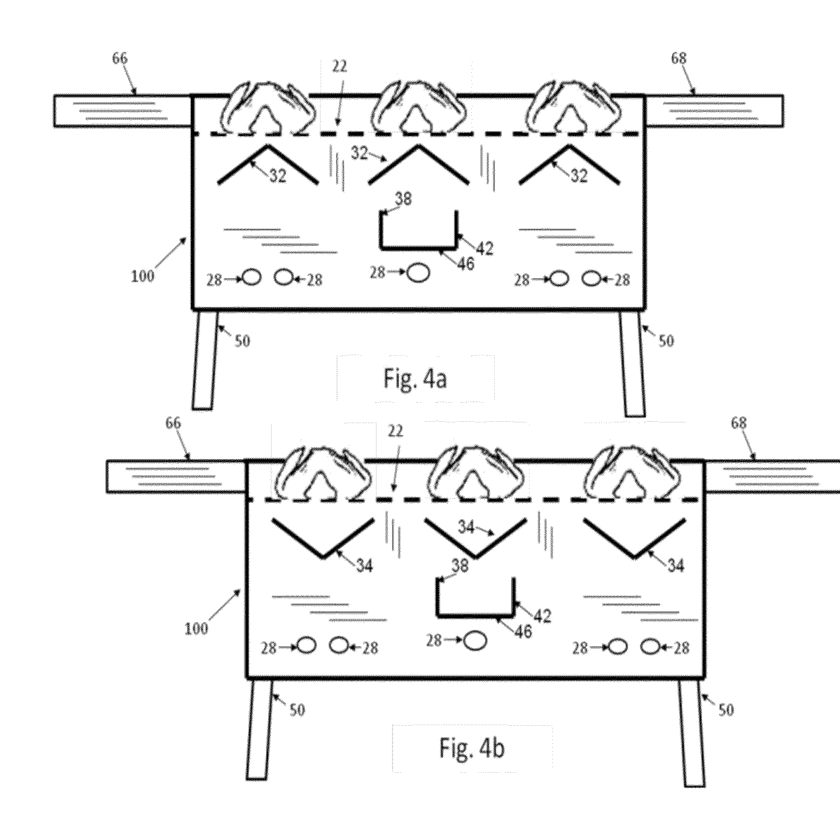

FIG. 4a is a sectional view of the cooking enclosure of grill 100 portraying the gas burners 28, the removable drawer 20, flavorizer bars 32, and superiorly placed cooking surfaces 22. The solid fuel drawer is shown, with the left surface 38, lower surface 36, and right surface 42. In this sectional image, the grill is configured for high temperature smoking.

FIG. 4b is a sectional view of the grill 100 when configured for low temperature smoking. In this case, the water trays 34 are placed into the enclosure 10 in the inverted manner, and filled with water. The drawer 20, whose surfaces 38, 46, and 42 are seen in section, is filled with solid fuel when in use. The flavoring process in this configuration may employ all the burner elements 28, if the ambient temperature is low, or may utilize a single burner element 28, directly below the solid fuel drawer 20. Alternatively, the burner element 28 may not be only to ignite the solid fuel in the solid fuel drawer 20, but the burner element 28 can be extinguished during the cooking session. Further, the water trays 34 act to lower temperatures. In this configuration, the grill achieves temperatures far lower than gas grills typically achieve. Through this configuration, the grill achieves temperatures below 250 degrees, which facilitates the low temperature smoking process. These temperatures, achieved through a variable utilization of burner elements 28 and solid fuel in solid fuel drawer 20, along with the improved humidity provided by the water trays 34, allow cooks to flavor their food with wood while maintaining high moisture levels, but still allowing the extended cooking times required to generating the connective tissue breakdown.

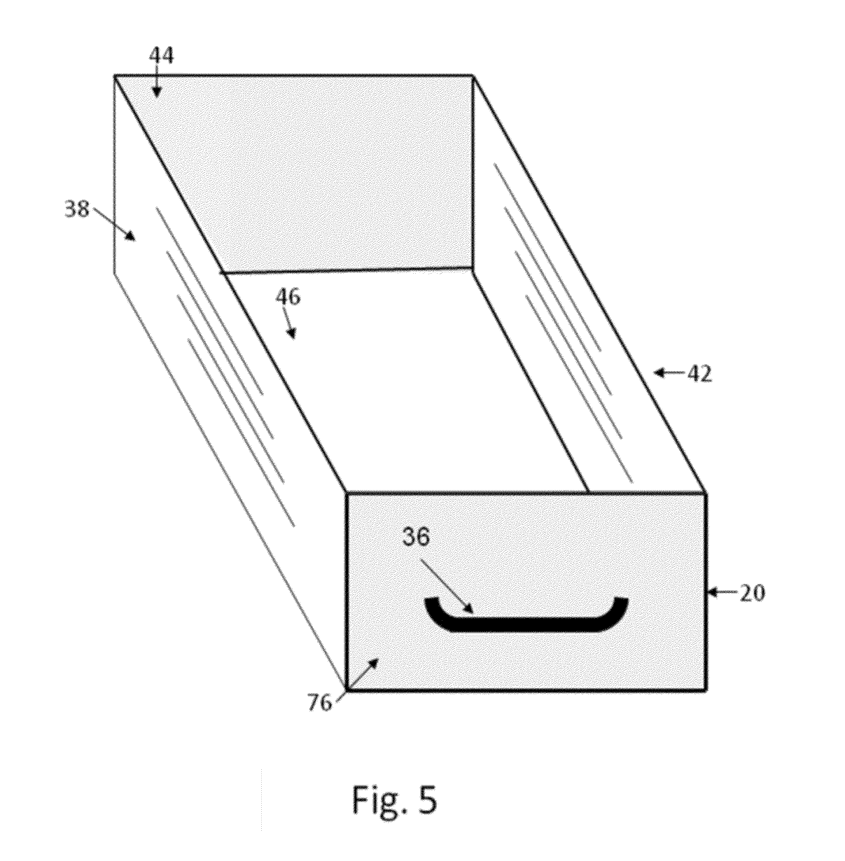

FIG. 5 is an isometric view of the refillable drawer 20, removed from the cooking device. The drawer 20 has a handle 36, a left sided surface 38, a front surface 76, a right sided surface 42, a back surface 44, and a lower surface 46. The solid fuel drawer 20 can be opened and filled during operation of the grill, preserving cooking temperatures inside the cooking enclosure 10.

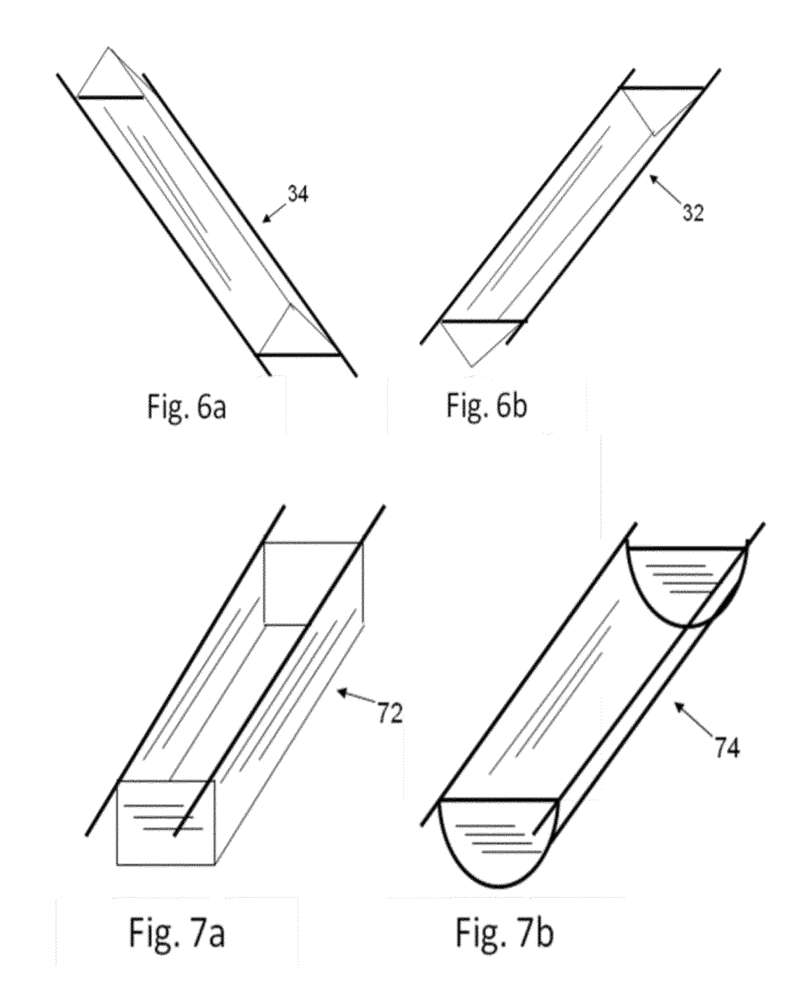

FIG. 6a discloses one embodiment of the flavorizer bar 34 of U.S. Pat. No. 4,627,408. However, unlike in disclosure in U.S. Pat. No. 4,627,408, the item 34 is structured such that when placed in an inverted position, it is capable of containing fluid. However, FIG. 6a retains its ability to prevent flare-ups, again as disclosed in U.S. Pat. No. 4,627,408. In FIG. 6b, the inverted position is disclosed. In this position, the water tray 32 will humidify the cooking environment and lower the realized cooking temperatures. FIGS. 6a and 6b are the same part in different positions, that when deployed in the cooking enclosure 10, significantly alter the function of the cooking apparatus.

FIGS. 7a and 7b disclose alternative embodiments of the water tray. In water tray 72, the water tray has a rectangular cross sectional shape. In water tray 72, the cross sectional shape is semi-lunar. In these embodiments, the water capacity is increased as compared to water tray 32.

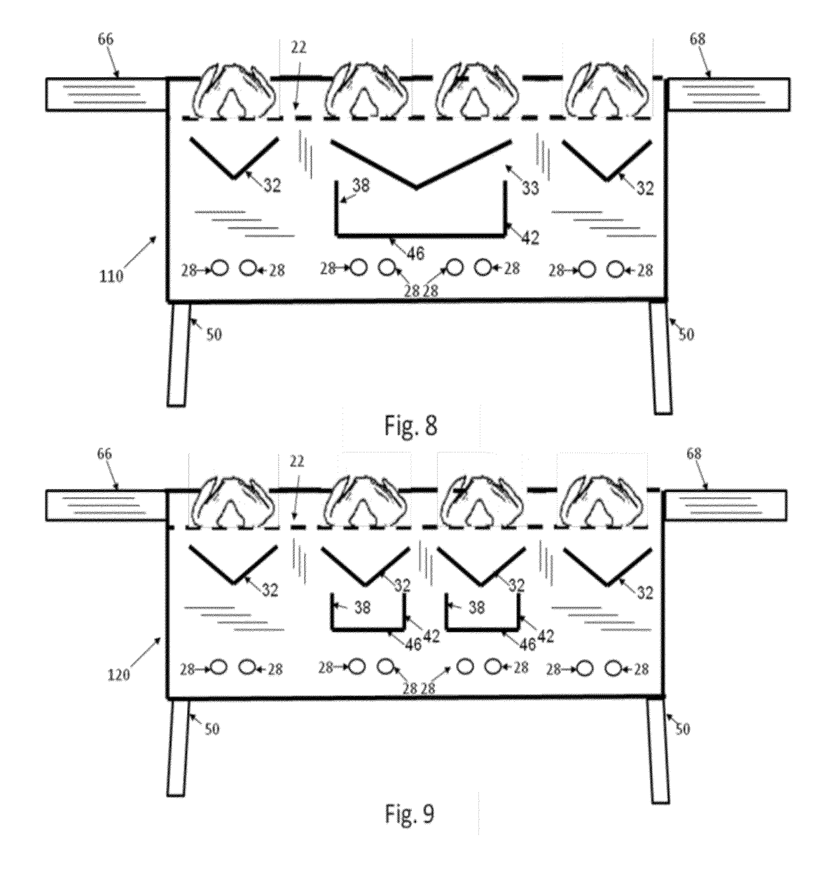

FIG. 8 discloses a sectional view of the second embodiment of the invention 110. Grill 110 retains the identical traits of grill 100 but for the following differences. Unlike the grill 100, this grill 110 has four burner elements 28 rather than three. The sectional view of the solid fuel drawer, disclosed in cross section as the left, bottom, and right surfaces 38, 46, and 42 respectively, is disclosed in a manner than the solid fuel drawer 20 spans the area above two burner elements, 28. Further, where the water tray 34 disclosed in FIG. 4b spans only one drawer, the water tray 33 in FIG. 8 spans the width of the solid fuel drawer 20, such that it retains its humidification and temperature reduction properties.

FIG. 9 discloses a sectional view of a third embodiment of the invention 120. Grill 120 retains the identical traits of grill 100, but for the following differences. Unlike grill 100, grill 120 has four burner elements 28 rather than three. Grill 120 discloses two solid fuel drawers 20, whose surfaces 38, 46, and 42 are seen is sectional view. Above the two solid fuel drawers are water trays 32.

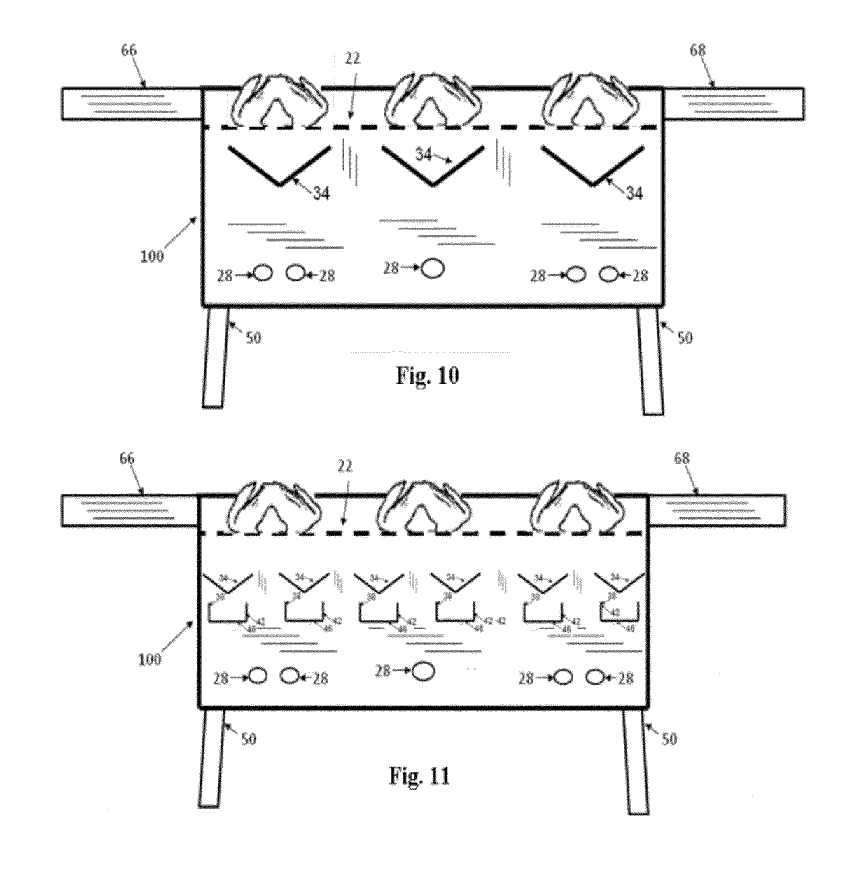

FIG. 10 discloses one embodiment of the current invention whereby the solid fuel drawer is not included, and only a liquid tray is positioned between the heat source and the grill and food location. Three are shown, however commensurate with the claims and embodiments consistent with the overall disclosure there may be between one liquid and tray and six liquid trays.

FIG. 11 discloses the outer range of six liquid trays and solid fuel drawers, and alternative embodiment commensurate with the claims and consistent with the over disclosure herein.

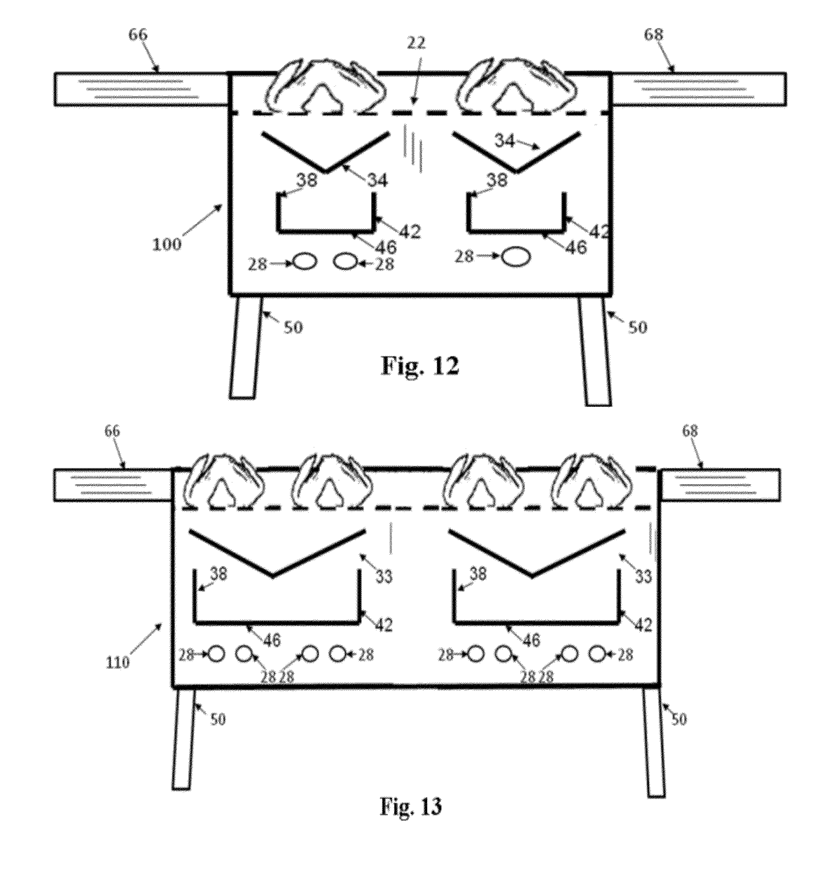

FIG. 12 discloses another embodiment of exactly two liquid trays and solid fuel drawers. Consistent with the overall disclosure herein the object of the current invention may be carried out through a number of different embodiments comprising a range solid fuel drawers and liquid trays from up to one more as described in this figure as well FIG. 11.

FIG. 13 discloses another embodiment of two solid fuel drawers and liquid trays, each drawer and liquid tray spanning two burners.

Table 1 discloses performance testing and data collection for one embodiment of the disclosed invention. Experimental design and explanations are shown here:

### Testing Grill Designs for Ability to Perform Low Temperature Smoking

### Hypothesis

Two grills are presented for evaluation of their ability to perform a low temperature smoking process. The first grill is configurable to contain a water tray or sear bar, and also contains an optional drawer for solid fuel. The second grill is disclosed in U.S. Pat. No. 5,878,739 (“Guidry”).

Null hypothesis: The grills are not capable of performing low temperature smoking.

### Procedure

### Step 1—High Temperature Grilling

Apr. 18, 2012, Dallas Tex.

Grill is configured for use as a gas grill. Flavorizer bar is in place. Solid fuel drawer is removed.

Yahoo weather reports the temp at 4 PM is 78 degrees and sunny, south winds of 10 mph and humidity of 45%.

The solid fuel drawer was constructed from galvanized steel flashing and is approximately 2 in×5 in×12 in.

The grill is in the shade.

Temp is being measured with a Ryobi noncontact infrared thermometer model IR-001 with temp range from −4 to 600 degrees Fahrenheit and a stated accuracy plus or minus 5 degrees Celsius. Readings were taken at less than 2 feet, as per the instructions.

The grill is a Fiesta Dickson 2-burner 25k BTU gas grill, modified with configurable solid fuel drawer and water tray in place of sear bar. The original grill grate has been replaced with a cast iron grate, which does not interfere with lid closure. This was done to get a better infrared reading.

Both burner elements are set to their highest setting during the experiment and the flap covering the opening for solid fuel drawer is in its closed position. The grill was never opened during the interregnum.

Temperatures will be observed before ignition, and at thirty minutes. Temps will be measured on the inside of the lid and at the grill grates themselves. Weather observations will be recorded.

### Step 2—Low Temperature Smoking

Apr. 18, 2012, Dallas Tex.

Grill is configured for use as a smoker. Water tray is in place and filled. Solid fuel drawer is installed. Solid fuel is hickory wood chips from WW Wood, topped with hickory chunks from WW Wood, and the drawer is completely filled.

Yahoo weather reports the temp at 5 PM is 78 degrees and sunny, SSE winds of 15 mph and humidity of 43%.

The solid fuel drawer was constructed from galvanized steel flashing and is approximately 2 in×5 in×12 in.

The grill is in the shade.

Temp is being measured with a Ryobi noncontact infrared thermometer model IR-001 with temp range from −4 to 600 degrees Fahrenheit and a stated accuracy plus or minus 5 degrees Celsius. Readings were taken at less than 2 feet, as per the instructions.

The grill is a Fiesta Dickson prototype, modified with configurable solid fuel drawer and water tray in place of sear bar. The original grill grate has been replaced with a cast iron grate, which does not interfere with lid closure. This was done to get a better infrared reading.

One burner element is set to their lowest setting during the experiment. The grill was never opened during the interregnum.

Temperatures will be observed before ignition, and at thirty minutes. Temps will be measured on the inside of the lid and at the grill grates themselves. Weather observations will be recorded.

Step 3—Evaluation of the Guidry U.S. Pat. No. 5,878,739

Apr. 18, 2012, Dallas Tex.

Grill is configured for use as a smoker. Water tray, extending to the left half of the internal width of the cooking enclosure, is in place and filled. The remaining width has a flavorizer bar in place. Solid fuel drawer is not installed, flap covering is in closed position. Solid fuel is hickory wood chunks from WW Wood. Two chunks are placed in front of, and two behind, the left burner element, and only underneath the water tray.

Yahoo weather reports the temp at 5 PM is 78 degrees and sunny, SSE winds of 15 mph and humidity of 43%.

The solid fuel drawer was constructed from galvanized steel flashing and is approximately 2 in×5 in×12 in.

The grill is in the shade.

Temp is being measured with a Ryobi noncontact infrared thermometer model IR-001 with temp range from −4 to 600 degrees Fahrenheit and a stated accuracy plus or minus 5 degrees Celsius. Readings were taken at less than 2 feet, as per the instructions.

The grill is a Fiesta Dickson prototype, modified with configurable solid fuel drawer and water tray in place of sear bar. The original grill grate has been replaced with a cast iron grate, which does not interfere with lid closure. This was done to get a better infrared reading.

To simulate the procedure limitations in Guidry, both burner elements, which extend the entire cooking area, are set to their lowest setting during the experiment. This simulates one burner element set to low. The grill was never opened during the interregnum.

Temperatures will be observed before ignition, and at thirty minutes. Temps will be measured on the inside of the lid and at the grill grates themselves. Weather observations will be recorded.

### RESULTS

See table 1 in the figures and drawings section.

Discussions and Analysis Solid fuel drawer and water tray

The solid fuel drawer and water tray achieved a sustained, consistent temperature of just higher than 200 degrees Fahrenheit. This is close to an ideal temperature. An achievement of a lower temperature is never a problem as heat can always be raised by toggling the burner elements.

For this grill design, the null hypothesis is rejected.

### Guidry Grill

It is an obvious drawback of the procedure that in the Guidry design, wood is directly exposed to flame. The wood actively burns in lieu of smoldering. This leads to higher temperatures than in Step 2, because the wood in Step 2 was only partially combusted. Simply stated, more heat calories were released in Step 3 than Step 2.

Unfortunately for anyone trying to smoke a brisket on the Guidry design, the placement of the wood is beneath the grill grates. For this reason, it is very difficult to refill the wood. Such a step would require removing the food from the grate, removing the water tray without spilling the boiling water, replacing the wood, then reversing each of these steps. This process would likely need to be performed hourly if not more often. One might think that the effort alone is enough to discourage consumers from taking these steps, but safety issues are also very relevant, as each of the parts are quite hot.

Even if one were willing to deal with the wood replacement process for each hour of a potentially twelve hour long cooking process, the temperatures significantly exceed comfortable slow smoking temperatures.

The experiment showed higher temperatures at 15 and 30 minutes, but even at one hour the temperatures only barely achieved the maximum temperature for low temperature smoking. The decline in temperatures was likely due to the nearly complete combustion of the wood chunks. This conclusion is based on direct observation of the chunks themselves.

### Additional Observations:

1. During step 2, smoke production was limited for the first 10-20 minutes. It improved before the first measurement.

2. The first step 2 grill grate measurement of 252 seemed inaccurate. I was able to touch the grill grate for 1.0 to 1.5 seconds before pulling back.

3. The step 2 grill grate required additional measurements. It was discovered that the laser was not in line with the sensor. It was later confirmed that the erroneous reading of 252 was the front portion of the grill, not the grate.
4. At the reading in Step 2 at one hour, I was again able to touch the grate for a max of 1-1.5 seconds.
5. At the end of Step 2, it was observes that significant water remained in the tray and most of the wood remained in the tray
6. Only one grill grate measurement was taken, rather than lateralizing measurements.
7. The solid fuel drawer in Step 2 contains four wood chunks and some chips to aid in ignition.
8. The same number of chunks were used in Step 3 as in the solid fuel drwaer in Step 2.
9.At Step 3 15 minutes in, it was observed (through gaps in the solid fuel drawer opening)that the chunks were actively burning.
10. At Step 3 1 hour in, it was observed that the chunks had stopped actively burning and were smaller, dark red coals.
11. At step 3 after one hour, it was observed that a small amount of water was left in the water tray.

The present invention uniquely enables a new, two step cooking process. First, the food is flavored, or cooked at low temperature with solid fuel smoke combustion. The wood here is not used a heat source, but rather as a kind of airborne marinade, where the strength of flavoring is related to time exposed to the marinade. This process occurs with a single heating element set to the lowest possible setting, in order to deliver extremely low cooking temperatures below 200 degrees, and food placed on the cooking apparatus in a manner that heat it only received indirectly. The resulting food product is parcooked. The second step is to raise the cooking temperature to above 325 degrees, to complete the cooking process. The user achieves these higher temperatures by actuating additional burner elements. This step herein is referred to as cooking to completion, and is demarcated by the food being fully cooked, as opposed to raw or undercooked, such that it is safe for consumption. This two step cooking process cannot be performed on traditional smokers, as they lack sufficient heating capability, or on traditional grills, which lack wood flavoring capability.

A further benefit of the current invention is the use of a drawer structure for combustion of the solid fuel. By design heat is conducted through the sides and bottom of the drawer and limits airflow, which may only enter through opening at the top, thus leading to incomplete combustion of the solid fuel. The solid fuel thereby lasts longer and smokes more. Among other attributes and benefits this process also yields byproducts that include NOx (nitrogen oxide or nitrogen dioxide for example) and CO (carbon monoxide). In a food product these react with myoglobin (a muscle cell oxygen binding protein similar to hemoglobin) to create what is known as the smoke ring, which is is desirable in barbecuing and smoking.

The liquid tray in any embodiment may be of a multitude of dimensions and sizes varying its size in all three dimensions. In certain embodiments a water tray of greater depth will absorb more heat over time and retain its liquid contents for a greater period of time. The size of the tray at its opening or upper end functions to limit or the release of steam. A deeper tray, with a narrower opening, will absorb more heat, last longer, and release steam for a greater period of time. A shallow tray with a wider opening and spanning a larger surface area above the burners operates towards the opposite end of the spectrum, releasing more steam over a shorter period of time. This water tray design is useful for a high humidity low temperature cooking period followed by a higher temperature period as the water evaporates and the heat sink disappears. Likewise, by using a tray of a wide surface area and greater depth the heat absorbing capacity is maximized providing the greatest cooling effect and keeping temperatures low. By designing the tray to be of a multitude of dimensions, width, length, and depth, the functions of humidifying, absorbing heat and controlling temperature, may be optimized as desired for the process.

In particular in reference to table 1, the grill of the current disclosure sustained 200 degree temperatures for an hour. In contrast to the design of the Guidry reference which showed almost 300 degrees at peak, declining over the hour as the caloric output of the wood chunks declined. Temp at one hour was 244, or barely in range of low temperature smoking.

What makes the this invention able to perform this technique is the combination of solid fuel integration with the ability to perform high temperature grilling, without even touching the food. It is similar to the well known dual temperature cooking technique used in home kitchens, where the food is initially seared on the stovetop, then placed in the oven to cook to completion.

But in this case, flavor comes not from searing, but from smoking. It is key in the first step to be able to achieve ultralow temperatures such that food is not at risk of actually cooking to completion, as such temperatures imply that the food can be overcooked. In fact, the production of heat is incidental to the first step of the process, as the objective is to flavor, not cook, the food. It is the object of this two step process.

In other embodiments, the humidifier bar function is provided for by a basin located within the grille bars themselves. Grille bars of any size that are hollow, and have an opening anywhere on the upper side are sufficient to accept water and provide the humidifying function. Other embodiments include hanging basins or baskets that may contain solid fuel or liquid and are placed into the grille container by being attached to wire or metal hangers that have hooks or other means that hang from the grille. These hanging containers are within the appropriate distance from the heat source to provide for the same smoking and humidifying functions disclosed herein. Similarly styled containers may also not employ the use of a hanging attachment and are simply placed in the bottom of the grille.

The invention may be enclosed in a number of standard enclosure and adaptations recognized as common in the art, such as cabinet, counter, island, mobile unit, or brick oven styled enclosure.

When used, grill contents generally refers to that which is found within the cooking chamber of the grill apparatus and comprises such things, if present in the embodiment, as liquid tray, the solid fuel drawer, the grill bars, the food being cooked inside the grill and other components that may be found in said chamber. An advantage of the current invention is that such contents in the chamber may remain undisturbed during the various cooking processes and techniques made capable by the device. Undisturbed refers to not having to intervene to adjust the internal contents of the cooking chamber, to carry out such tasks as but not limited to refilling the fuel source, gas, charcoal, or solid fuel, add or adjust the water, rotate, remove, or otherwise adjust the food, opening and closing the lid of the grill chamber, and other standard tasks in cooking. In other embodiments the only disturbance with the grill involves refilling the solid fuel drawer(s), however the lid does not require opening and the other contents inside the chamber are undisturbed. The varied cooking techniques disclosed herein can be, but are not required to be, carried out on the current device without the requirement to adjust and intervene with the contents of the cooking chamber as is needed by devices in the related art.

The invention further provides means for delivering flavoring, marinades, and treatment of food in phases, at desired times and under different conditions, by controlling temperature and contents of the dual drawers accordingly. The flavoring, marinade, or treatment can be adjusted in phases by controlling three basic conditions of heat, smoke, and humidity. This allows for a controllable multiple phase differential cooking using six broad range factors—the temperature, low temperature up to high temperature and searing, smoking and the flavor of the smoke, the humidity and the type or flavor of the steam (using sweet flavored liquids, wines, teas or spices, etc.).

It will be seen that a new and useful gas grill has been illustrated and described, and it will be obvious to those skilled in the art that various changes, modifications, and additions can be made without sacrificing the essence of the invention. For example, the bottom surface of the drawers will vary in a manner allowing for improved transfer of heat. Another change would involve alterations of the placement and number of burners, the placement of the drawers, or the size of the grill. The second embodiment may have telescoping arms added, such that the size is variable and it can be placed into grills of varying sizes. These and other changes may be made without sacrificing the unique capability of the device to perform simple grilling, fast smoking, slow smoking, and simulation of cooking over a wood fire.

TABLE 1

| | Step 1 | Step 2 - 30 mins | Step 3 - 1 hour | Step 3 - 15 mins | Step 3 - 30 mins | Step 3 - 1 hour |
|---|---|---|---|---|---|---|
| Starting temp at grill grate | 76.4 | 76.3 | N/A | 69.1 | N/A | N/A |
| Starting temp at inside of lid | 76.2 | 76.4 | N/A | 69.2 | N/A | N/A |
| Ending temp at grill grate | 580 | 203 | 202 | 293 | 271 | 244 |
| Ending temp at inside of lid | 420 | 171 | 150 | 318 | 908 | 284 |
| Water temp (if applicable) | N/A | 161 | 171 | not checked | 201 | 193 |
| Starting time | 16:38 | 19:40 | N/A | 21:34 | N/A | N/A |
| Ending time | 17:07 | 20:14 | 20:50 | 21:49 | 22:06 | 22:34 |
| Starting temp | 78 | 76 | 74 | 71 | N/A | N/A |
| Starting humidity | 45 | 45 | 45 | 47 | N/A | N/A |
| Starting wind | S 10 mph | SSE 12 | SSE 13 | SE 13 | N/A | N/A |

I claim:

1. A modular portable grill, comprising:
a. an enclosure defining a cooking chamber, the enclosure including a first pair of opposed sides and a second pair of opposed sides defined generally perpendicular to the first pair of opposed sides;
b. cooking surfaces operably connected to the enclosure;
c. a heating system operably connected to the enclosure, wherein the heating system includes a plurality of burner elements, wherein the plurality of burner elements are operative to heat the cooking chamber;
d. a user interface operably connected to the burner elements, wherein the user interface allows the user to set and adjust a desired temperature for each of the heating zones;
e. in proximity to one or more of the heating elements, a removable drawer for combustion of solid fuel;
f. above the solid fuel drawer, a liquid tray, for humidification and temperature reduction.

2. The modular portable grill in claim 1, wherein the grill can be integrated into at least one of a:
cabinet, counter, island, or mobile unit.

3. The modular portable grill in claim 1, where at least one gas burner is integrated into side portions of the grill body.

4. The modular portable grill in claim 1, where at least one infrared side burner is integrated into side portions of the grill body.

5. The modular portable grill in claim 1, comprising a drawer element and liquid tray that spans two heating elements.

6. The modular portable grill in claim 1, where there are between two and six solid fuel drawers and liquid trays.

7. The modular portable grill in claim 1, where there are two solid fuel drawers and liquid trays, each drawer and liquid tray spanning two burners.

8. The modular portable grill in claim 1, where the burner elements comprise infrared heating elements.

9. The modular portable grill in claim 1, where the burner elements comprise electric resistance heating elements.

10. The modular portable grill in claim 1, where the burner elements comprise natural gas heating elements.

11. The modular portable grill in claim 1, where the liquid tray is operably connected to the cooking surface.

12. A modular portable grill, comprising:
a. an enclosure defining a cooking chamber, the enclosure including a first pair of opposed sides and a second pair of opposed sides defined generally perpendicular to the first pair of opposed sides;
b. cooking surfaces operably connected to the enclosure;
c. a heating system operably connected to the enclosure, wherein the heating system includes a plurality of burner elements, wherein the plurality of burner elements are operative to heat the cooking chamber;
d. a user interface operably connected to the burner elements, wherein the user interface allows the user to set and adjust a desired temperature for each of the heating zones;
e. above the burner elements, a liquid tray, for humidification and temperature reduction.

13. A method for dual temperature cooking within a single device comprising:
a. parcooking on the apparatus of claim 1, at less than 250 degrees, over a first period of time.
b. cooking to completion on said apparatus over a second period of time, at greater than 325 degrees.

14. The method of claim 17, wherein the food is flavored by burning solid fuel during all or part of the total cooking time.

15. The method of claim 17, wherein the food is humidified during all or part of the two cooking steps.

16. This method of claim 17, wherein element a) is carried out with indirect heat actuated by a single burner, and element b) is achieved with direct heat actuated by at least single burner.

17. A method for dual temperature cooking within a single device comprising:
a. parcooking on the apparatus of claim 16, at less than 250 degrees, over a first period of time.
b. cooking to completion on said apparatus over a second period of time, at greater than 325 degrees.

18. A method for low temperature smoking on a gas grill comprising:
a. the device of claim 1, wherein the cooking temperature is below 212 degrees.

19. The method of claim 18, wherein the grill contents are undisturbed during the cooking process and the cooking process is at least two hours.
